(19) United States
(12) Patent Application Publication
(10) Pub. No.: US 2023/0369871 A1
(43) Pub. Date: Nov. 16, 2023

(54) PATIENT SUPPORT WITH ELECTRONIC DEVICE WIRELESS CHARGING

(71) Applicant: Hill-Rom Services, Inc., Batesville, IN (US)

(72) Inventor: Joshua Lee Meyer, Batesville, IN (US)

(21) Appl. No.: 18/144,973

(22) Filed: May 9, 2023

Related U.S. Application Data
(60) Provisional application No. 63/341,257, filed on May 12, 2022.

(51) Int. Cl. H02J 7/00; A61G 7/05; H02J 50/10

(52) U.S. Cl. CPC H02J 7/0042; A61G 7/05; H02J 50/10; A61G 2203/70

(57) ABSTRACT

A patient support apparatus includes a frame with a head end and a foot end. A support arm is operably coupled to the head end of the frame and a vertical support is operably coupled to the support arm. A user interface support assembly is operably coupled to the vertical support and includes a housing that is configured to retain an electronic device. The housing includes a support mechanism that is configured to selectively support the electronic device on the housing. A charging assembly is disposed within the housing and is configured to charge the electronic device secured on the housing.

### CROSS-REFERENCE TO RELATED APPLICATION

This application claims priority to and the benefit under 35 U.S.C. § 119(e) of U.S. Provisional Application No. 63/341,257, filed on May 12, 2022, entitled “PATIENT SUPPORT WITH ELECTRONIC DEVICE WIRELESS CHARGING,” the disclosure of which is hereby incorporated herein by reference in its entirety.

### FIELD OF THE DISCLOSURE

The present disclosure generally relates to a patient support, and more particularly to a patient support with electronic device wireless charging capabilities.

### SUMMARY OF THE DISCLOSURE

According to one aspect of the present disclosure, a patient support apparatus includes a frame with a head end and a foot end. A support arm is operably coupled to the head end of the frame and a vertical support is operably coupled to the support arm. A user interface support assembly is operably coupled to the vertical support and includes a housing that is configured to retain an electronic device. The housing includes a support mechanism that is configured to selectively support the electronic device on the housing. A charging assembly is disposed within the housing and is configured to charge the electronic device secured on the housing.

According to another aspect of the present disclosure, a patient support apparatus includes a frame that has a head end and a foot end. A support arm is operably coupled to the head end of the frame and a vertical support is operably coupled to the support arm. A housing is operably coupled to the vertical support and is configured to retain an electronic device. The housing includes a support mechanism that is configured to selectively support the electronic device on the housing. The support mechanism defines a shelf and a dynamic engagement member. A charging assembly is disposed proximate a rear side of the housing and is configured to wirelessly charge the electronic device secured on the housing.

According to yet another aspect of the present disclosure, a user interface support assembly for a patient support apparatus includes a vertical support and a housing that is operably coupled with the vertical support. At least one handle extends from the housing. A support mechanism is configured to selectively support an electronic device on the housing. The support mechanism defines a shelf and a dynamic engagement member. A charging assembly is disposed proximate a rear side of the housing and is configured to wirelessly charge the electronic device secured on the housing.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of a patient support apparatus of the present disclosure;

FIG. 2 is a front elevational view of a housing according to the present disclosure;

FIG. 3 is a top perspective exploded view of a housing including wireless charging functionality;

FIG. 4 is a side perspective view of an electronic device supported on a housing of the present disclosure; and

FIG. 5 is a block diagram of a user interface support assembly interaction with an electronic device, according to one aspect of the present disclosure.

### DETAILED DESCRIPTION

The present illustrated embodiments reside primarily in combinations of method steps and apparatus components related to a patient support with electronic device wireless charging. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

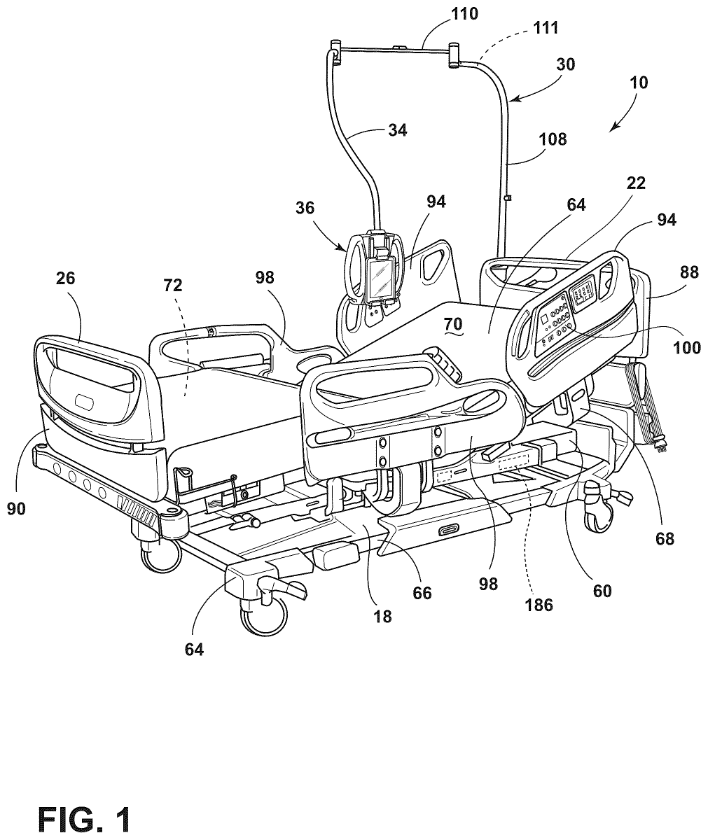

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface closest to an intended viewer, and the term “rear” shall refer to a surface furthest from the intended viewer. However, it is to be understood that the disclosure may assume various alternative orientations, except where expressly specified to the contrary. It is also to be understood that the specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-4, reference numeral 10 generally designates a patient support apparatus that includes a frame 18 with a head end 22 and a foot end 26. A support arm 30 is operably coupled to the head end 22 of the frame 18 and a vertical support 34 is operably coupled to the support arm 30. A user interface support assembly 36 is operably coupled to the vertical support 34 and includes a housing 40 that is configured to retain an electronic device 44. The housing 40 includes a support mechanism 50 configured to selectively support the electronic device 44 on the housing 40. A charging assembly 54 is disposed within the housing 40 and is configured to charge the electronic device 44 that is secured on the housing 40.

Referring now to FIG. 1, the patient support apparatus 10 may include a hospital bed.

While described as the patient support apparatus 10, it is within the scope of the disclosure that the patient support apparatus 10 may include a bed frame 60, a mattress 64, or any suitable structure for supporting a patient, including, but not limited to: other types of beds, surgical tables, examination tables, stretchers, recliners, and the like.

As illustrated in FIG. 1, the patient support apparatus 10 includes a base frame 66 and an upper frame 68 that may be coupled with the base frame 66. The upper frame 68 may be operable between raised, lowered, and tilted positions relative to the base frame 66. The patient support apparatus 10 also includes a patient support surface 70 that is defined by the mattress 64, which is supported by at least one of the base frame 66 and the upper frame 68. The mattress 64 may be in the form of a cushion including a foam base 72 and multiple layers.

The patient support apparatus 10 includes the head end 22 and the foot end 26. A headboard 88 is provided at the head end 22 and a footboard 90 is provided at the foot end 26. The patient support apparatus 10 may include a pair of head siderail assemblies 94 and a pair of foot siderail assemblies 98. The pair of head siderail assemblies 94 and the pair of foot siderail assemblies 98 are useful in lessening the likelihood that a patient accidentally moves from the bed and assists in maintaining covers and patient support warming accessories in position on the patient. In some examples, an interface 100, which may be a graphical user interface, may be coupled to an external side of at least one siderail of the head and foot siderail assemblies 94, 98.

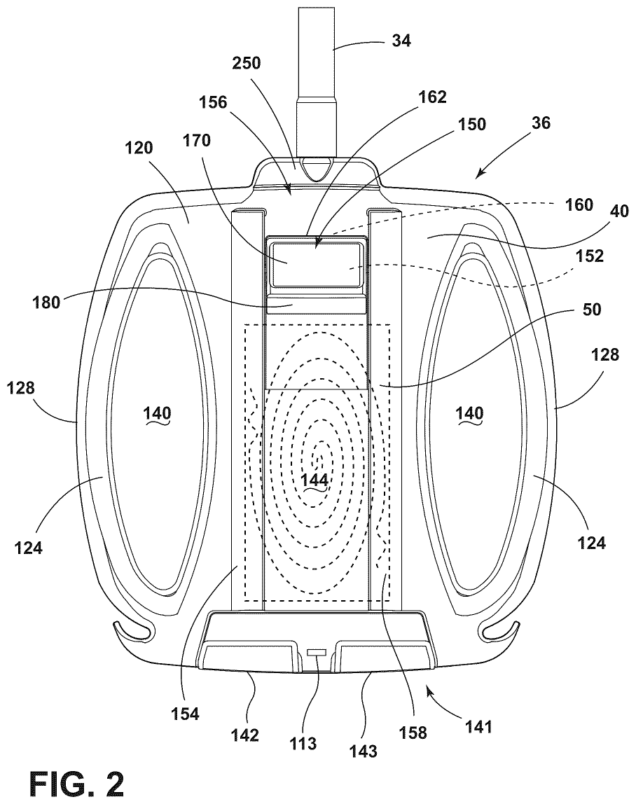

As illustrated in FIG. 1, the support arm 30 is coupled with the head end 22 of the patient support apparatus 10. Alternatively, the support arm 30 may be coupled with of at least one of the head and foot siderail assemblies 94, 98, or with one of the base frame 66 and the upper frame 68, but is not limited to such examples. The support arm 30 generally includes a fixed portion 108 and a pivotable portion 110. The pivotable portion 110 extends laterally from the fixed portion 108 and is configured to rotate relative to the fixed portion 108. The pivotable portion 110 is operably coupled with the housing 40. Notably, each of the support arm 30, the pivotable portion 110, and the vertical support 34 include a hollow construction configured to convey a cord 111 therethrough. The cord 111 is configured to convey power and/or data to the housing 40. The power provided through the cord 111 may be used to power a charger disposed within the housing 40. In addition, or alternatively, the power supplied through the cord 111 may be operably coupled with an outlet 113 (FIG. 2). The outlet 113 may be in the form of a Universal Serial Bus (“USB”) outlet configured to receive any of a variety of USB cables including USB-A, USB-B, and USB-C connectors, among others. The outlet 113 may convey power and/or data to the electronic device 44 via an electronic device connector. The outlet 113 may include a cover, such as a spring-loaded door, to keep the outlet covered and protected from debris when not in use.

The vertical support 34 may be a flexible cord or a generally rigid vertical member, may depend from the pivotable portion 110, and may be repositioned to a variety of locations about the patient support apparatus 10 depending on user preference. The housing 40 may be pivotally or rotatably coupled with the vertical support 34. The pivotable portion 110 and/or the vertical support 34 generally have exceptional flexibility to provide support for accessing the housing 40 at different angles and positions relative to the patient support apparatus 10. However, the housing 40 may be integrated with any suitable component of the patient support apparatus 10.

The electronic device 44 defines a user interface in the form of a tablet, laptop, smart phone, etc. that may be secured to the housing 40, which may be used by a caregiver or a patient. The electronic device 44 may include touch screen functionality and may be generally rectangular in shape. However, it is also contemplated that the electronic device 44 may be of various other shapes, which can be secured to the housing 40. As set forth herein, the electronic device 44 may be configured to receive power from the wireless charging assembly 54. Alternatively, or in combination, the electronic device 44 may receive power and/or data via the electronic device connector in communication with the electronic device 44 and the outlet 113.

Referring now to FIG. 2, the housing 40 is illustrated. The illustrated housing 40 includes a forward wall 120 and a rearward wall 121. The housing 40 has at least one gripping surface 124, which may include one or more handles 128. As illustrated, the housing 40 includes two handles 128 that each extend from the forward wall 120 to a lower portion of the housing 40. The handles 128 may be covered in a material, such as a soft, silicone to provide an enhanced gripping surface and which is easily cleanable. In addition, or alternatively, the handles 128 may include a textured or knurled grip with a high coefficient of friction that aids a user in maintaining a grip on the housing 40. The forward wall 120 and the rearward wall 121 are secured to one another by fasteners 130 which are concealed by plugs 132. The plugs 132 provide for a more easily cleanable surface on the rearward wall 121. The rearward wall 121 is also connected with upper and lower support plates 134, 135. The lower support plate 135 includes an aperture 136 through which a plug 138 extends. The plug 138 may pass through the rearward wall 121 and may be in electrical communication with one or more circuit boards within the housing 40, as explained in further detail herein. The plug 138 may include an outlet 139 that is any type of connector outlet, including USB-A, USB-B, and USB-C connectors, among others. The plug 138 is generally configured to provide a connecting outlet for a patient or caregiver to connect the electronic device 44 to the rearward wall 121 of the housing 40. The outlet 139 of the plug 138 may be configured to supply power and/or data to the electronic device 44.

In some examples, as illustrated in FIG. 2, the handles 128 extend outwardly from the housing 40 to define apertures 140. The apertures 140 are generally oval, elliptical, or lanceolate shaped and may be dimensioned such that a hand of a user can reach at least partially through one of the apertures 140, which may be beneficial for grasping the housing 40 or one of the handles 128. The support mechanism 50 is disposed proximate a middle portion of the housing 40, which may be located between the apertures 140. The forward wall 120 of the housing 40 also has a shelf 141 that has shelf members 142, 143 which are disposed at a bottom portion of the housing 40 and which are configured to support items including, but not limited to, books, magazines, electronic devices 44, etc. A charging interface 144 is located between the shelf 141 and the vertical support 34. The charging interface 144 is configured to transfer power to the electronic device 44 via any of a number of methods such as inductive coupling and capacitive coupling, as set forth herein. One non-limiting example of a support mechanism is set forth in commonly assigned U.S. Patent Application Publication No. 2021/0007920, the disclosure of which is incorporated herein in its entirety. However, it is within the scope of this disclosure for other support mechanisms and for the housing 40 to include alternative gripping arrangements, which may or may not include the apertures 140. For example, one or more handlebars, cup handles, pull handles, or knobs, etc. may extend from the housing 40 to facilitate moving and gripping of the housing 40.

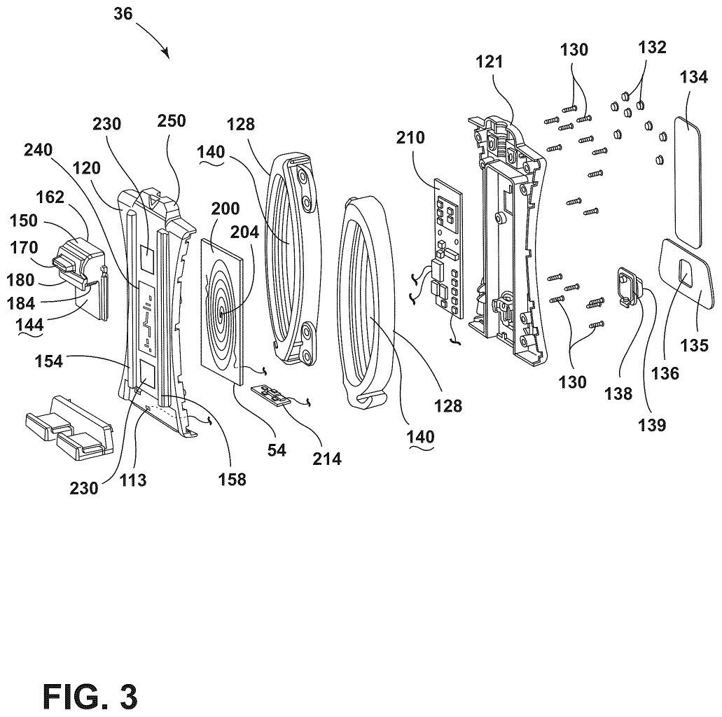

With reference now to FIGS. 2 and 3, the support mechanism 50 may include a dynamic engagement member such as a latch actuator 150 that has a latch mechanism 152 for selectively releasing a locking body 156. Release of the locking body 156 enables the locking body 156 to be vertically slidable within first and second opposing channels 154, 158. At least a portion of the latch mechanism 152 may be disposed within an interior 160 of an upper end 162 of the locking body 156. The upper end 162 may be in the form of a curved body that extends outwardly from a planar portion of the locking body 156. Alternatively, the upper end 162 may be any suitable shape, which may be rectangular or flat and which may include a non-slip cleanable surface.

In various examples, the latch actuator 150 includes a button 170, which may be generally flush with the upper end 162. Thus, the button 170 generally includes a shape complementary to the shape of the upper end 162. In addition to the button 170 being flush with the upper end 162, molding the button 170 in the same color as the locking body 156 may provide the aesthetically pleasing appearance of a seamless interface between the button 170 and the locking body 156. Moreover, the button 170 generally has a continuously arcuate outer surface, which contributes to the seamless interface between the button 170 and the locking body 156. While illustrated as the button 170, the latch actuator 150 may include any suitable component for actuating the latch mechanism 152, which may include, but not limited to: a tab, a handle, a push-button, a toggle, etc. The button 170 may be spring-biased to a raised position away from the shelf members 142, 143.

It will be understood that the latch mechanism 152 may include an internal ratchet assembly configured to disengage when the button 170 is depressed so that the locking body 156 of the latch actuator 150 can move and engage when locking body 156 of the latch actuator 150 is released so that the latch actuator 150 cannot move. As a result, the locking body 156 of the latch actuator 150 and the latch mechanism 152 can be used to secure the electronic device 44 against the housing 40. It is also contemplated that the locking body 156 may freely move downward at any time and that depressing the button 170 will allow the locking body 156 to travel upward.

As shown in FIG. 2, the shelf 141 is coupled with the bottom portion of the housing 40, which is dimensioned to receive an edge, which may be a lower edge, of the electronic device 44 (FIG. 1). As illustrated, the shelf 141 includes the first shelf member 142 and the second shelf member 143, which extend upward to retain the edge of the electronic device 44. However, the shelf 141 may be in any suitable configuration that provides a surface for the electronic device 44, which may include a single, continuous portion and may or may not extend upwardly.

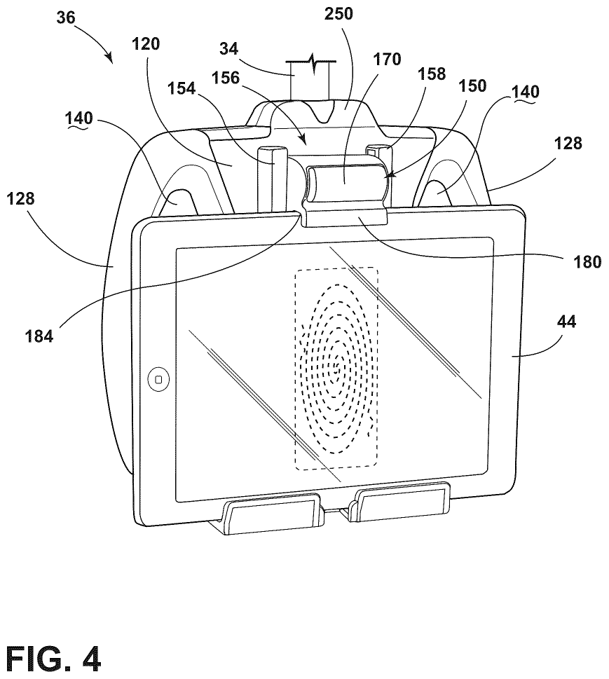

Additionally, the locking body 156 includes a flange 180, which extends downwardly from the latch actuator 150 thereby defining a recess 184 (FIG. 4). The recess 184 is dimensioned to receive another edge of the electronic device 44, which may be an upper edge. The height, or position, of the flange 180 and the recess 184 is adjusted by repositioning the locking body 156. Thus, the electronic device 44 may be secured to the housing 40 in a clamping manner by way of the shelf 141 and the flange 180. In this way, the housing 40 may accommodate an electronic device 44 of a variety of sizes.

With reference now to FIGS. 2-4, the charging assembly 54 of the present disclosure is generally configured to wirelessly charge or power the various electronic devices 44 that may be placed on the housing 40 proximate the charging interface 144. It will be understood that any of a number of wireless charging methods may be utilized to charge the electronic device 44. In addition, the charging assembly 54 may be incorporated into a larger charging system that is configured to power various components and accessories of the patient support apparatus 10, such as those set forth in commonly assigned U.S. patent application Ser. No. 17/708,100, entitled “WIRELESS POWER DISTRIBUTION IN PATIENT SUPPORT SURFACE.” As previously noted, inductive coupling and capacitive coupling, among other power transfer methods may be utilized to transfer power from the charging interface 144 to the electronic device 44. These types of power transfers do not require a plug in an outlet, thereby minimizing the number of surfaces that need to be cleaned during the course of care to a patient. Further, the charging interface 144 maintains an easily cleanable power interface that can be quickly wiped off, cleaned, and sanitized. As a result, a clean and sterile environment can be provided to a patient with minimal effort and time.

With reference now to FIG. 3, it is also contemplated that the charging assembly 54, as set forth herein, may be in communication with a direct power source 185 and/or a battery source 186 that is operably coupled to the patient support apparatus 10. The battery source 186 may supply other components of the patient support apparatus 10 or may be a battery source 186 solely dedicated to providing wireless charging capability between the housing 40 and the electronic device 44 positioned on the housing 40.

With reference again to FIG. 3, as well as FIG. 4, in one instance, where inductive coupling is used to transfer power, it is contemplated that the charging assembly 54 may include a circuit board assembly that is in electrical communication with an inductive plate 200 and a transmitting coil 204. The inductive plate 200 and the transmitting coil 204, collectively understood to be a transmitting element 208, are disposed within the housing 40 and are generally disposed directly behind the forward wall 120 of the housing 40. The transmitting element 208 is configured to interact with a receiving element 209 of the electronic device 44 at the charging interface 144. It will be understood that although the transmitting element 208 is disposed within the housing 40 proximate the charging interface 144, the transmitting element 208 could be placed further within the housing 40. However, it is believed that optimum charging may occur with the transmitting coil 204 placed closer to the forward wall 120 of the housing 40. A primary circuit board 210 acts to monitor and control the amount of wireless charging that is capable by the transmitting element 208. A secondary circuit board 214 may also be in communication with the electronic device 44 (when proximate the housing 40) and the primary circuit board 210. The secondary circuit board 214 may control charging speed or include a breaker, for example. In addition, either or both of the primary circuit board 210 and the secondary circuit board 214 may control not only the flow of power through the charging assembly 54 and/or the outlet 113 and/or the outlet 139, but may also control the flow and speed of data available at the outlet 113 and at the outlet 139 of plug 138. At least one of the primary circuit board 210 and the secondary circuit board 214 may control power output at the transmitting element 208. As previously noted, the charging assembly 54 may be in communication with the direct power source 185, such as a wall outlet. The charging assembly 54 may also be in contact with the battery source 186 of the patient support apparatus 10. If either the primary circuit board 210 to the secondary circuit board 214 detects a lower power condition of the battery source 186, the primary circuit board 210 or the secondary circuit board 214 may restrict or limit charging capability at the charging interface 144 so that any component or accessory operably coupled with the patient support apparatus 10, and which provide health related features to the patient, can be maintained.

In one non-limiting example of an inductive coupling arrangement, the transmitting element 208, disposed within the housing 40, and the receiving element 209, disposed within the electronic device 44, are both configured as coils. The transmitting coil 204 is configured to interact with a receiving coil disposed within the electronic device 44. An alternating current is then generated through the transmitting element 208 to create an oscillating magnetic or electromagnetic field between the transmitting element 208 and the receiving element 209 of the electronic device 44. The oscillating magnetic or electromagnetic field occurs at the charging interface 144. The electromagnetic field passes through the receiving element 209 of the electronic device 44 to induce an alternating voltage. The electronic device 44 includes circuitry configured to capture or extract power from the electromagnetic field and convert that power into energy in the form of electricity. The electronic device 44 also includes circuitry for directing and controlling the power supply such that overcharging cannot occur.

In one non-limiting example of a capacitive coupling arrangement, the transmitting element 208 and the receiving element 209 within the electronic device 44 are generally configured as electrodes. An alternating voltage is applied to the transmitting element 208 by the power source 185 that extends through the vertical support 34. This results in an oscillating electric field that generally induces an alternating potential on the transmitting element 208. Capacitance is used for the transfer of power between the transmitting element 208 and the receiving element 209 within the electronic device 44. Any space between the transmitting element 208 and the receiving element 209 of the electronic device 44 serves as a dielectric. The electronic device 44 includes circuitry to capture or extract power from the electric field and convert that power into energy in the form of electricity. The electronic device 44 also includes circuitry for directing and controlling the power supply such that overcharging does not occur.

It is contemplated that other forms of wireless power transmission may be employed in the charging assembly 54 and may include, for example, magnetic resonance, loose-coupled resonance, electromagnetic radiation, etc. without departing from the teachings set forth herein.

Regardless of whether capacitive or inductive charging is utilized, when the electronic device 44 is positioned within a predefined distance from the transmitting element 208, the charging interface 144 acts to wirelessly transmit power from the transmitting element 208 to the receiving element 209 within the electronic device 44. Generally, for greater energy transfer, the predefined distance is less than or equal to about 5 mm. Lesser energy can be transferred over larger distances, such as less than or equal to about 10 cm. The receiving element 209 of the electronic device 44 collects the energy from the charging interface 144, converts the energy to electricity, and transfers the energy to a battery within the electronic device 44. The energy can then be stored and utilized to activate features of the electronic device 44 at a later time or concurrently during charging.

With reference again to FIGS. 2-4, notably, the transmitting coil 204 at the charging interface 144 is rather large and extends nearly all the way between the apertures 140. The large size of the transmitting coil 204 provides for charging electronic devices 44 that are larger in size, such as a laptop or tablet, and also may allow for charging multiple smaller electronic devices 44, such as two or more phones, concurrently. It will be noted that the alignment between the receiving element 209 of any electronic device 44 and the transmitting element 208 may affect the efficiency of power transfer at the charging interface 144. To aid in proper alignment, the latch mechanism 152 and shelf 141 may be useful. Alternatively, or in addition to the latch mechanism 152 and shelf 141 features provided on the housing 40, the forward wall 120 of the housing 40 may include magnetic features 230 disposed on the forward wall 120 of the housing 40. The magnetic features 230 may be configured to attract and secure one or more electronic devices 44 against the forward wall 120 of the housing 40 without interfering with the transfer of energy by the charging interface 144. Consequently, a proper charging arrangement can be maintained.

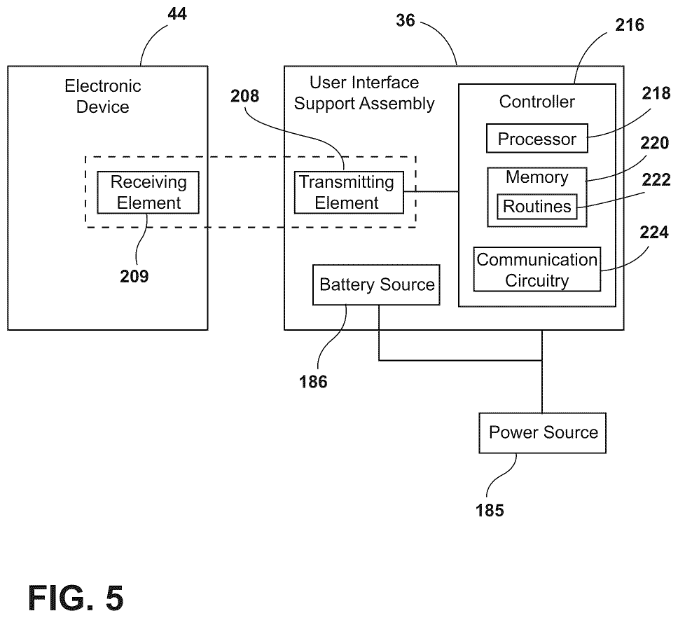

With reference now to FIG. 5, one exemplary construction of the user interface support assembly 36 is illustrated. In this exemplary construction, the charging interface 144 includes the transmitting element 208, which is operably coupled with a controller 216 that includes a processor 218. The controller 216 also includes a memory 220 configured to store routines 222 as they are carried out by the processor 218. In addition, the controller 216 includes communication circuitry 224 configured to communicate with the transmitting element 208. The user interface support assembly 36 may be audibly coupled with the battery source 186, the power source 185, or both the battery source 186 and the power source 185. When an electronic device 44 is placed on the forward wall 120 of the housing 40, at the charging interface 144, the transmitting element 208 of the housing 40 is in electrical communication with the receiving element 209 of the electronic device 44. The controller 216 monitors a charge status of the battery source 186 and if the charge status of the battery source 186 falls below a pre-defined threshold, then the controller 216 will limit or otherwise deactivate the transmitting element 208 such that the transmitting element 208 does not further drain the power source 185 to charge the receiving element 209 of the electronic device 44. Stated differently, if the battery source 186 has a low charge, the controller 216 may deactivate or limit the power supply from the transmitting element 208 of the housing 40 to the receiving element 209 of the electronic device 44, to minimize or eliminate a further drain of the power source 185.

Alternatively, or in addition to the magnetic features 230, the housing 40 may include audible, visual, or tactile indicia in the form of a sound, visual effect, or vibration, that notifies a patient or caregiver that a proper power connection has been arranged between the electronic device 44 and the housing 40 at the charging interface 144. Although many electronic devices notify a user when the electronic device is being charged, the system set forth herein may also be configured to provide a notification to the patient or caregiver that at least one electronic device 44 is being charged at the charging interface 144. A sensor 240 at the charging interface 144 may detect a power draw at the charging interface 144. On detection of a power draw, the controller 216, at the primary circuit board 210 or the secondary circuit board 214, activates a charging indicator 250, resulting in a notification to the patient or caregiver that the electronic device 44 or electronic devices 44 are being charged. In the illustrated configuration of FIG. 2, the charging indicator 250 is in the form of a visual indicator and is disposed proximate to a top portion of the housing 40. The visual indicator assists a caregiver in knowing if one or more electronic devices 44 is being charged when the caregiver is standing even a substantial distance from the housing 40.

According to one aspect of the present disclosure, patient support apparatus includes a frame with a head end and a foot end. A support arm is operably coupled to the head end of the frame and a vertical support is operably coupled to the support arm. A user interface support assembly is operably coupled to the vertical support and includes a housing that is configured to retain an electronic device. The housing includes a support mechanism that is configured to selectively support the electronic device on the housing. A charging assembly is disposed within the housing and is configured to charge the electronic device secured on the housing.

According to another aspect of the present disclosure, a housing includes a forward wall with a transmitting coil that is disposed within the housing.

According to another aspect of the present disclosure, a transmitting coil is disposed proximate a forward wall of a housing.

According to still another aspect of the present disclosure, a charging assembly includes an inductive coupling arrangement.

According to another aspect of the present disclosure, a housing includes a latch mechanism and a shelf. The latch mechanism is configured to secure an electronic device on the shelf.

According to yet another aspect of the present disclosure, a housing includes a latch mechanism that is configured to secure an electronic device in abutting contact with the housing.

According to another aspect of the present disclosure, a housing is in communication with a battery source that is operably coupled to a patient support apparatus.

According to still another aspect of the present disclosure, a patient support apparatus includes a controller that monitors a battery source of the patient support apparatus and limits charging of an electronic device when the battery source of the patient support apparatus has a low charge.

According to another aspect of the present disclosure, a patient support apparatus includes a frame that has a head end and a foot end. A support arm is operably coupled to the head end of the frame and a vertical support is operably coupled to the support arm. A housing is operably coupled to the vertical support and is configured to retain an electronic device. The housing includes a support mechanism that is configured to selectively support the electronic device on the housing. The support mechanism defines a shelf and a dynamic engagement member. A charging assembly is disposed proximate a rear side of the housing and is configured to wirelessly charge the electronic device secured on the housing.

According to another aspect of the present disclosure, a patient support apparatus includes an outlet that is configured to supply at least one of power and data to an electronic device connector.

According to still another aspect of the present disclosure, a patient support apparatus includes magnetic features that secure the electronic device to a forward wall of the housing

According to another aspect of the present disclosure, an outlet includes a spring-loaded door that keeps the outlet covered when not in use.

According to yet another aspect of the present disclosure, a patient support apparatus includes a latch mechanism that is configured to secure an electronic device in abutting contact with a forward wall of a housing.

According to another aspect of the present disclosure, a transmitting coil is disposed within a housing.

According to still another aspect of the present disclosure, a transmitting coil extends across a width of a housing and is configured to charge multiple electronic devices concurrently.

According to another aspect of the present disclosure, a user interface support assembly for a patient support apparatus includes a vertical support and a housing that is operably coupled with the vertical support. At least one handle extends from the housing. A support mechanism is configured to selectively support an electronic device on the housing. The support mechanism defines a shelf and a dynamic engagement member. A charging assembly is disposed proximate a rear side of the housing and is configured to wirelessly charge the electronic device secured on the housing.

According to yet another aspect of the present disclosure, a charging assembly is operably coupled with a charging indicator.

According to still another aspect of the present disclosure, a charging indicator includes visual indicia that activates when an electronic device is charging.

According to another aspect of the present disclosure, a user interface support assembly for a patient support apparatus includes a controller that monitors a battery source of the patient support apparatus and limits charging of an electronic device when the battery source of the patient support apparatus has a low charge.

According to another aspect of the present disclosure, a user interface support assembly for a patient support apparatus includes magnetic features that secure an electronic device to a forward wall of a housing.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A patient support apparatus, comprising:
a frame having a head end and a foot end;
a support arm operably coupled to the head end of the frame;
a vertical support operably coupled to the support arm; and
a user interface support assembly operably coupled to the vertical support, the user interface support assembly including a housing configured to retain an electronic device, the housing including:
a support mechanism configured to selectively support the electronic device on the housing; and
a charging assembly disposed within the housing and configured to charge the electronic device secured on the housing.

2. The patient support apparatus of claim 1, wherein the housing includes a forward wall with a transmitting coil that is disposed within the housing.

3. The patient support apparatus of claim 2, wherein the transmitting coil is disposed proximate the forward wall of the housing.

4. The patient support apparatus of claim 1, wherein the charging assembly includes an inductive coupling arrangement.

5. The patient support apparatus of claim 1, wherein the housing includes a latch mechanism and a shelf, and wherein the latch mechanism is configured to secure the electronic device on the shelf.

6. The patient support apparatus of claim 1, wherein the housing includes a latch mechanism configured to secure the electronic device in abutting contact with the housing.

7. The patient support apparatus of claim 1, wherein the housing is in communication with a battery source operably coupled to said patient support apparatus.

8. The patient support apparatus of claim 7, further comprising:
a controller that monitors the battery source of said patient support apparatus and limits charging of the electronic device when the battery source of said patient support apparatus has a low charge.

9. A patient support apparatus, comprising:
a frame having a head end and a foot end;
a support arm operably coupled to the head end of the frame;
a vertical support operably coupled to the support arm; and
a housing operably coupled to the vertical support and configured to retain an electronic device, the housing including:
a support mechanism configured to selectively support the electronic device on the housing, the support mechanism defining a shelf and a dynamic engagement member; and
a charging assembly disposed proximate a rear side of the housing and configured to wirelessly charge the electronic device secured on the housing.

10. The patient support apparatus of claim 9, further comprising:
an outlet configured to supply at least one of power and data to an electronic device connector.

11. The patient support apparatus of claim 9, further comprising:
magnetic features that secure the electronic device to a forward wall of the housing.

12. The patient support apparatus of claim 10, wherein the outlet includes a spring-loaded door that keeps the outlet covered when not in use.

13. The patient support apparatus of claim 9, wherein the housing is in communication with a battery source operably coupled to said patient support apparatus.

14. The patient support apparatus of claim 13, further comprising:
a controller that monitors the battery source of said patient support apparatus and limits charging of the electronic device when the battery source of said patient support apparatus has a low charge.

15. The patient support apparatus of claim 9, wherein a transmitting coil extends across a width of the housing and is configured to charge multiple electronic devices concurrently.

16. A user interface support assembly for a patient support apparatus comprising:
a vertical support;
a housing operably coupled with the vertical support;
at least one handle extending from the housing;
a support mechanism configured to selectively support an electronic device on the housing, the support mechanism defining a shelf and a dynamic engagement member; and
a charging assembly disposed proximate a rear side of the housing and configured to wirelessly charge the electronic device secured on the housing.

17. The user interface support assembly of claim 16 wherein the charging assembly is operably coupled with a charging indicator.

18. The user interface support assembly of claim 17, wherein the charging indicator includes visual indicia that activates when the electronic device is charging.

19. The user interface support assembly of claim 16, further comprising:
a controller that monitors a battery source of said patient support apparatus and limits charging of the electronic device when the battery source of said patient support apparatus has a low charge.

20. The user interface support assembly of claim 16, wherein the charging assembly includes an inductive coupling arrangement.
